(19) United States
(12) Patent Application Publication
(10) Pub. No.: US 2006/0077812 A1
(43) Pub. Date: Apr. 13, 2006

(54) Player/recorder, contents playing back method and contents recording method

(75) Inventors: Masaru Takahashi, Yokohama (JP); Keisuke Inata, Tokyo (JP); Yuuichi Kubo, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/173,731

(22) Filed: Jun. 30, 2005

(30) Foreign Application Priority Data
Sep. 16, 2004 (JP) 2004-269109

(51) Int. Cl. G11B 19/02

(52) U.S. Cl. 369/47.1; 369/59.1

(57) ABSTRACT

In order to protect the copyright of content and to achieve fast playback of content and improvement in the operability of a player/recorder, content are encrypted and recorded to a removable first recording medium by using a key unique to the first recording medium and, at the same time, content are encrypted and recorded to an included second recording medium using the key unique to the first recording medium.

### BACKGROUND OF THE INVENTION

1. Field of the Invention

The present invention relates to a player/recorder for controlling recording and playing back stored content.

2. Description of the Related Art

JP-A-2000-322826 discloses a conventional a player/recorder system that maintains the right of private copying by users and, at the same time, allows proper copyright protection, as well as a data processor centrally functioning in the player/recorder system. It also discloses a technology in which “main data (such as music data) recorded in a first recording medium is encrypted by a first device using an identifier unique to a first device as a key before the main data is transmitted to a second device to copy or move to a second recording medium. Then, the encrypted main data is transmitted to the second device to copy or move.”

According to this document, however, for the second device to play back main data recorded in the second recording medium, the played back encrypted main data is decrypted in the first device. In other words, to play back content, the content first must be transmitted to another device, which is different from the player, and then decrypted in the other device and returned to the player. Therefore, the system is not suitable for fast processing.

### BRIEF SUMMARY OF THE INVENTION

This invention provides a player/recorder, a playback method and a recording method allowing proper copyright protection, while, at the same time, enabling fast processing in playing back content. The invention includes a system that records on a first removable recording medium content encrypted with a first key unique to that medium and records the same data on a second recording medium contained in the player/recorder.

This system can prevent illegal copies which infringe copyrights since a key unique to a first recording medium is required for playing back content recorded in the second recording medium, which requires the first recording medium to be installed. Furthermore, operability is improved since the second recording medium is contained in the player/recorder and is suitable for fast processing such as fast playback. Furthermore, good user-operability can be achieved since the first recording medium is removable and the content therein can be carried only in the first recording medium for playback by a different device.

The invention provides a player/recorder, a content playback method and a content recording method, all having improved operability.

### BRIEF DESCRIPTION OF THE DRAWINGS

FIG. 1 is an entire construction diagram of a player/recorder system including a player/recorder according to a first exemplary embodiment;

FIG. 2 is a block diagram of the player/recorder according to the first exemplary embodiment;

FIG. 3 is a flowchart illustrating steps of data moving processing according to the first exemplary embodiment;

FIGS. 4A and 4B show an example of recording states on disks according to the first exemplary embodiment;

FIG. 5 is a chart illustrating a signal flow in data moving processing according to the first exemplary embodiment;

FIG. 6 is a block diagram of a player/recorder according to a second exemplary embodiment;

FIG. 7 is a flowchart of the steps for playback processing according to the second exemplary embodiment; and

FIGS. 8A and 8B show an example of recording states on disks according to the second exemplary embodiment.

### DETAILED DESCRIPTION OF THE INVENTION

In one embodiment, the following description uses an optical disk 1 as the removable first recording medium and an internal HDD 8 as a second recording medium contained in a player/recorder. Of course, other recording media can also be used. Each of the recording media may be a disk or memory including a magnetic disk and needs only to achieve faster playback processing from the second recording medium than the playback processing from the first recording medium in order to enable fast processing, which is the object of the invention.

Exemplary embodiments 1 and 2, below, include the following examples. In exemplary embodiment 1, the copyright of broadcast content can be protected, and, at the same time, fast playback processing can be achieved. In exemplary embodiment 2, the copyright of content recorded in a distributed recording medium 1 can be protected, and, at the same time, fast playback processing can be achieved.

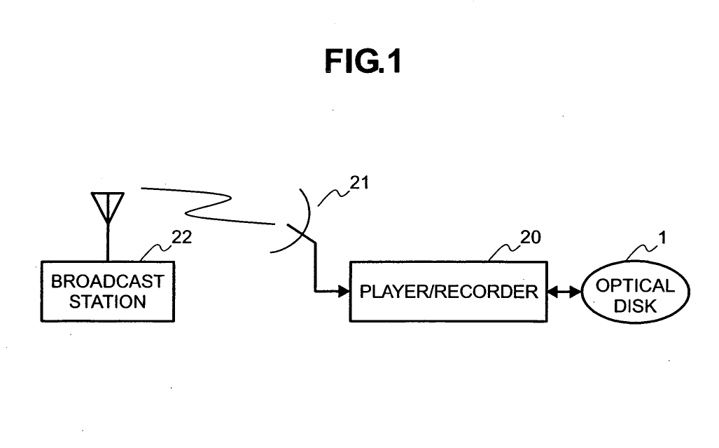

FIG. 1 shows an exemplary configuration of a player/recorder system including a player/recorder. A broadcast station 22 broadcasts content by radio, and an antenna 21 receives/transmits the content to a player/recorder 20. Then, player/recorder 20 records/plays back the received content. The optical disk 1 is removably attached to player/recorder 20. The content can also be recorded/played back to/from optical disk 1.

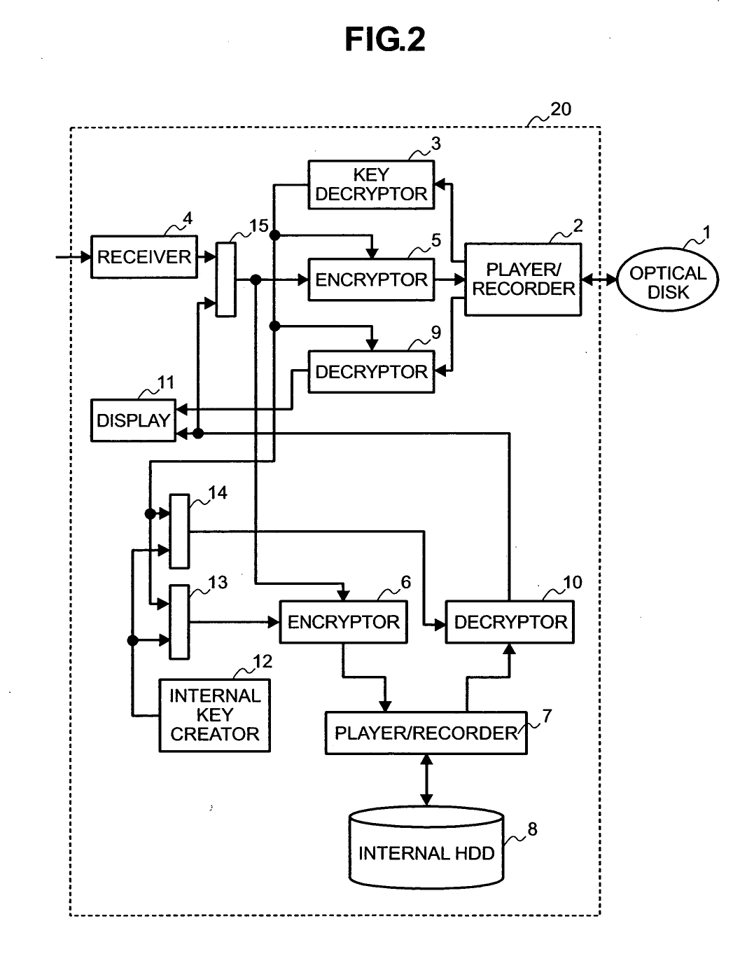

FIG. 2 is a block diagram of player/recorder 20. A display 11 (such as a video display) is integrally provided in this example, but player/recorder 20 may be connected to a display such as an external display for display instead of being set up as an integrated display.

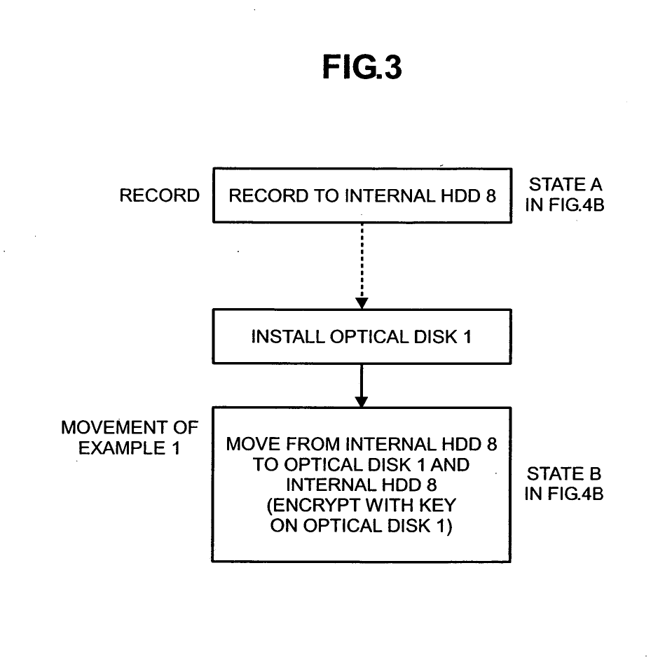

FIG. 3 is a flowchart of the steps for data recording and moving operations in player/recorder 20. First, a recording operation of exemplary embodiment 1 is described with reference to FIGS. 2 and 3. Optical disk 1 is not required for this recording operation since the recording operation records onto a hard disk 8 (herein “internal HDD 8”) contained in player/recorder 20. A receiver 4 receives copy-limited content, such as a digital broadcast, and a selector 15 selects and transmits the content to an encryptor 6. In encryptor 6, the content are encrypted with key data, and the encrypted content are recorded onto internal HDD 8 by a player/recorder 7. The management information is also recorded onto internal HDD 8. The key data for use in the encryption is data unique to the player/recorder and is created by an internal key creator 12. A elector 13 selects the key data, and encryption is performed with that data.

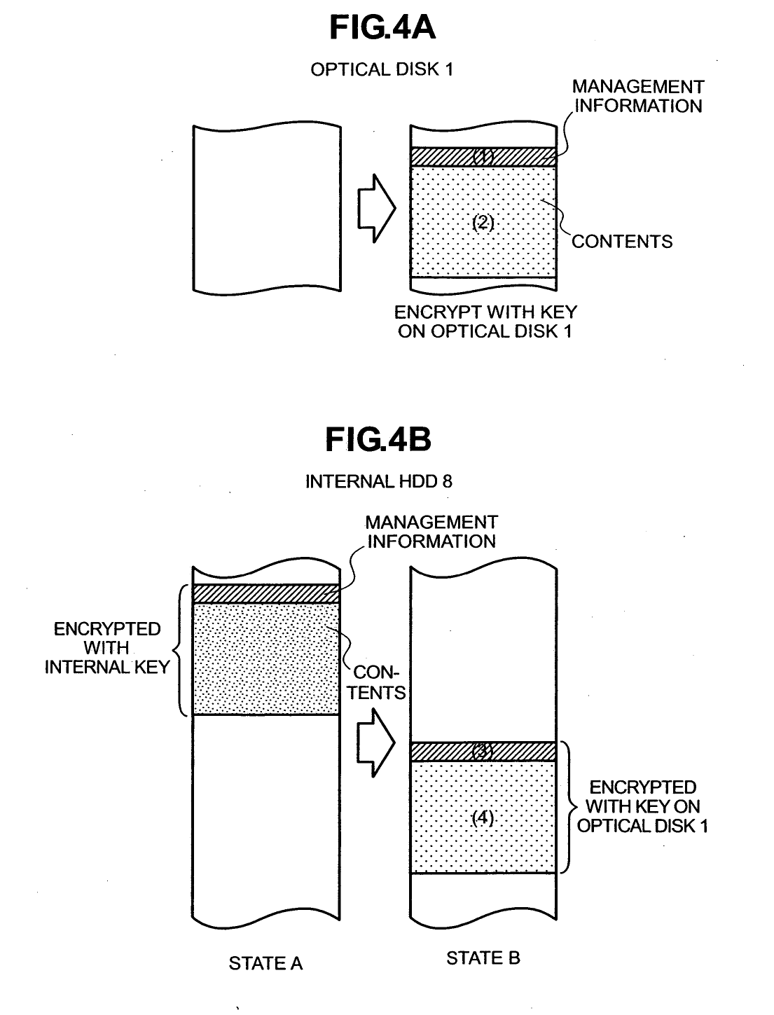

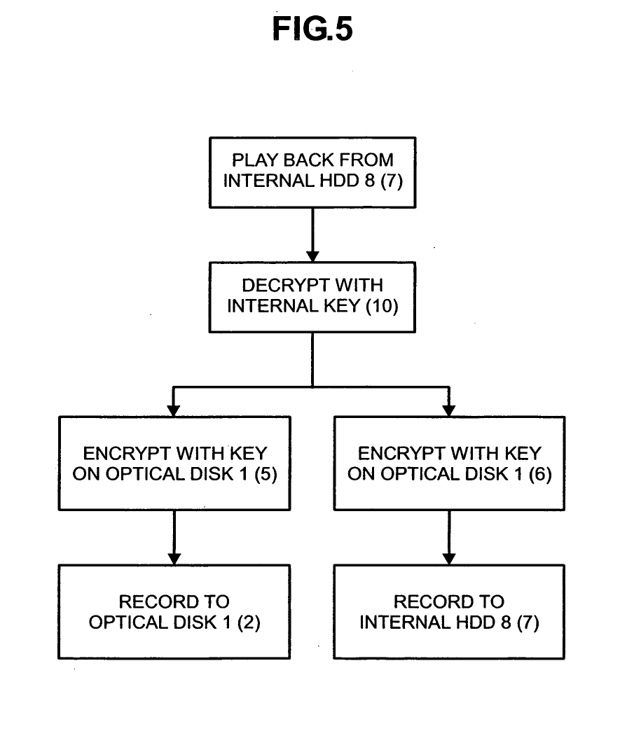

FIGS. 4A and 4B show recording states on optical disk 1 and internal HDD 8. State A indicates the state after the recording operation ends. Content and management information encrypted with an internal key are recorded only on internal HDD 8. Content allowing the recording only once (so-called copy-once content) may be copied to another medium by a moving operation. In the data moving operation, the copied original file is generally deleted to prevent more copies. FIG. 5 shows a signal flow in the data moving operation of this example. The numbers in parentheses refer to the corresponding reference numerals of the components in FIG. 2.

The data moving operation in exemplary embodiment 1 is described below with reference to FIGS. 2, 3 and 5. First, optical disk 1 is installed in player/recorder 20 by an operator (not shown). Next, key data encrypted on optical disk 1 is loaded by player/recorder 2, and key decryptor 3 decrypts the key data. Next, the content encrypted with an internal key recorded on internal HDD 8 are played back by player/recorder 7 and are decrypted by decryptor 10. Decryption in decryptor 10 can be achieved with a key created by internal key creator 12 and selected and supplied by selector 14. On the other hand, selector 15 selects and transmits the decrypted content to encryptors 5 and 6. Encryptor 5 encrypts the content with key data on optical disk 1, and the encrypted content are recorded on optical disk 1 by player/recorder 2. Management information on optical disk 1 is also updated.

In contrast, encryptor 6 encrypts the content with key data, and player/recorder 7 records the encrypted content on internal HDD 8. In this case, selector 13 selects key data unique to optical disk 1, and encryption is performed with the key data on optical disk 1. The same management information that is on optical disk 1 is also recorded on internal HDD 8. When copy processing ends, the content and management information encrypted with the internal key are deleted. State B in FIGS. 4A and 4B represents the states after data moving processing ends. The content and management information encrypted with the key on optical disk 1 are recorded on optical disk 1 and internal HDD 8.

The moving operation of exemplary embodiment 1 was described above. According to this example, the copying to internal HDD 8 is effectively limited because the encryption is implemented with a key unique to optical disk 1, which must be installed. Decryption cannot be performed without optical disk 1. In other words, decryption is not allowed by installing a different optical disk in order to copy the content to a different optical disk, the copy is disabled, which provides copyright protection. Thus, even when copy-once content are moved, the copy can be left on internal HDD 8. Leaving the copy on internal HDD 8 can improve the operability. For example, since internal HDD 8 has a higher recording/playback rate and a short access time for seeking, the fast playback speed is improved, and random access response time is reduced. Other players can play back content when optical disk 1 with the content is installed, which improves user operability with copyright protection.

The key unique to optical disk 1 retains security even when the unique key is known, because the unique key is stored in an area protected from recording by a general player/recorder.

Although the same data are encrypted and recorded onto optical disk 1 and internal HDD 8 in this example, the data can be recorded in different formats, which can improve operability. Examples of recording in different formats include:

I: recording content encoded differently onto optical disk 1 and internal HDD 8; and

II: recording content compressed onto optical disk 1 while recording content on internal HDD 8 without compression.

In a specific example of format I, content are recorded on optical disk 1 by MPEG 2 to allow the content to be played back by a generally available player whereas content are recorded on internal HDD 8 by MPEG 4 for superior compression efficiency. Since the content recorded on internal HDD 8 are expected to be played back by a player/recorder containing internal HDD 8, the content need to be recorded only in the encoding method of the player/recorder. Therefore, only an encoding method suitable for reducing the recording capacity and improving the image quality needs to be selected. In this way, the number of opportunities for playing back content on other players can be increased, and, at the same time, the efficiency of internal HDD 8 can be improved with copyright protection by changing the encoding method of the content in accordance with each recording medium.

In another specific example of format I, content can be recorded on the optical disk 1 and internal HDD 8 in different compression rates of the data. Since, the capacity of internal HDD 8 is generally large, content are recorded with a low compression rate and high image quality. Thus, a compression rate suitable for the capacity of a recording medium can be adopted, and optimum use of the recording medium can be achieved.

A specific example of format II is as follows. Video content is often recorded on a disk by compressing the content in interframe predictive coding such as MPEG. Because internal HDD 8 has a large capacity, the content may be recorded uncompressed. Since the random access of MPEG can be achieved only about every 0.5 second, which is called GOP (Group Of Picture), special kinds of playback, such as reverse playback, cannot easily be performed. However, recording the content uncompressed allows random access in frames, which can facilitate special kinds of playback.

In a broadcast system, the playback content of player/recorder 20, which receives and records the content and playback content recorded on optical disk 1, can be played back by a different device and may need to be differentiated. In this case, as described above, differentiation can be addressed by changing formats for recording content.

When the different player is a mobile terminal and player/recorder 20 is stationary, the forms of recording content thereon may be properly differentiated in accordance with the recording capacities of the selected recording forms.

Next, a playback operation of exemplary embodiment 1 is described. First, optical disk 1 is installed into player/recorder 20 by an operator (not shown). Next, encrypted key data on optical disk 1 is loaded by player/recorder 2, and the key data is decrypted by key decryptor 3. Next, the content (4) in FIG. 4B are played back through player/recorder 7 and decryptor 10 and are displayed on display 11. The decryption by decryptor 10 is achieved by a key on optical disk 1, which is selected and supplied by selector 14.

The playback operation of exemplary embodiment 1 provides the advantage of improved operability, which was discussed in the description of the data moving operation. This advantage is obtained by playback information on internal HDD 8.

In this example, the invention is applied to a broadcast system, but the invention is not limited thereto. The invention is also applicable when content transmission from a server over the Internet is received by player/recorder 20.

As described with reference to FIGS. 3, 4A and 4B and 5, content are again recorded on internal HDD 8 when the data are moved from internal HDD 8 to optical disk 1 and internal HDD 8 in this example. However, the invention is not limited thereto. The content do not have to be re-recorded on internal HDD 8 because the content are controlled to allow playback only when optical disk 1 is installed. However, as in the example, content may again be encrypted with a key on optical disk 1 and may be re-recorded for higher security.

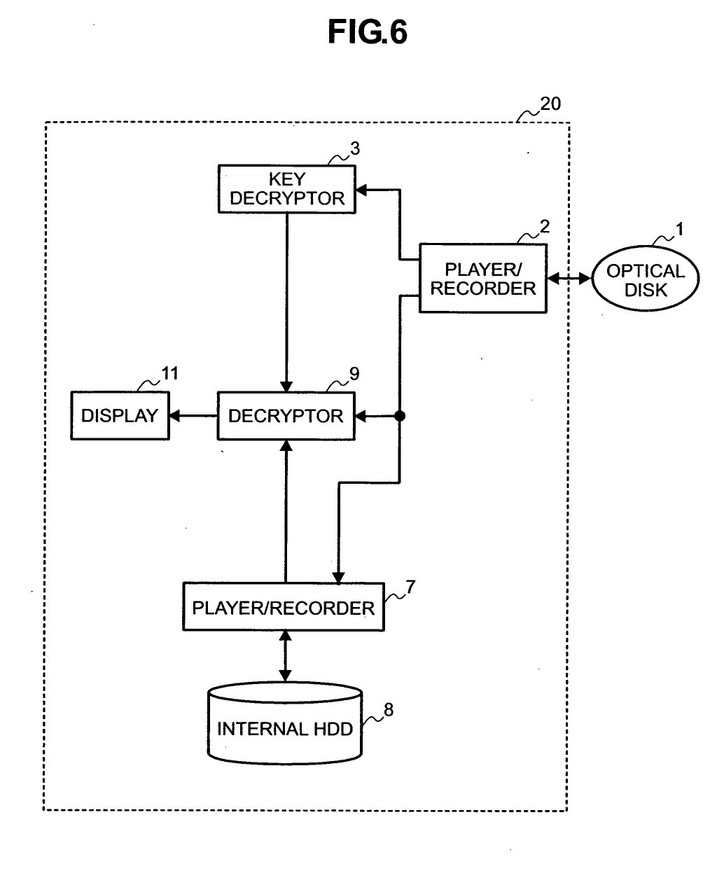

FIG. 6 is a block diagram of a player/recorder according to a second exemplary embodiment of the invention. A recording operation of Example 2 is described below with reference to FIG. 6. First, optical disk 1 is installed in the player/recorder by an operator (not shown). Next, player/recorder 2 loads encrypted content from optical disk 1, and the encrypted content are recorded on internal HDD 8 by player/recorder 7. The same management information as that on optical disk 1 is also recorded onto internal HDD 8.

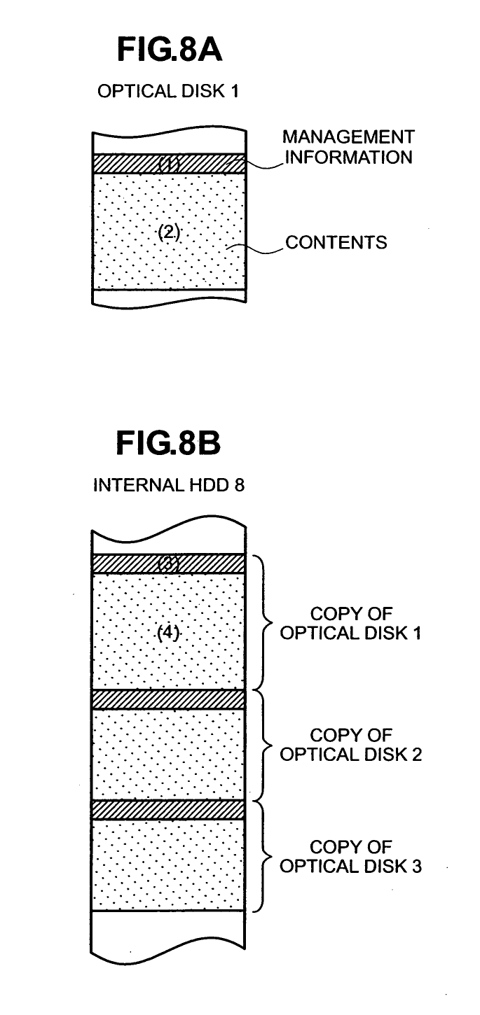

FIGS. 8A and 8B illustrate recording states of optical disk 1 and internal HDD 8. The same management copies (3) and (4) as the management information (1) and content (2) to be recorded on the optical disk 1 are recorded on internal HDD 8. Subsequently, copies are sequentially recorded in different areas every time a disk to be installed is exchanged.

The recording operation of exemplary embodiment 2 was described above. According to this example, since the copies on internal HDD 8 are encrypted with a key unique to optical disk 1 to install, decryption cannot be performed without installing optical disk 1, thereby achieving an effective copy limit. Thus, even copy-protected content can be copied on internal HDD 8, thereby improving operability. For example, because internal HDD 8 has a higher recording/playing back rate and a shorter access time for seeking, for example, the fast playback speed can be improved, and the random access response time can be reduced.

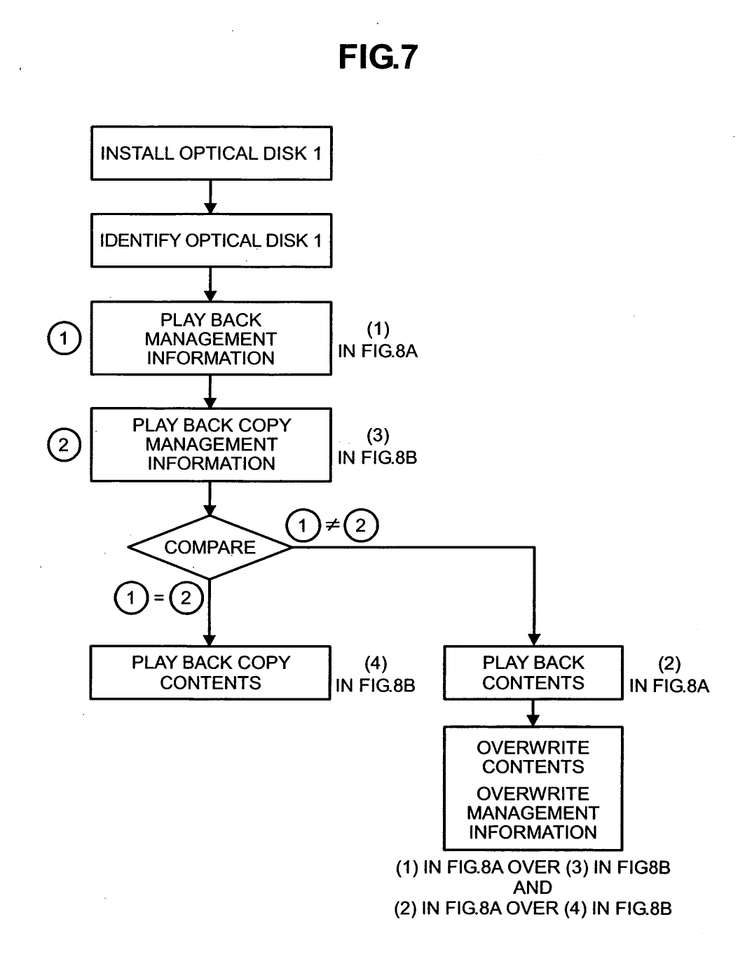

FIG. 7 is a flowchart of the playback steps according to exemplary embodiment 2. A playback operation of this embodiment is described below with reference to FIGS. 6 and 7. First, optical disk 1 is installed in the player/recorder by an operator (not shown). Next, player/recorder 2 plays back encrypted key data on optical disk 1, and key decryptor 3 decrypts the key data. Next, a system controller (not shown) identifies optical disk 1 based on information played back from optical disk 1. Once optical disk 1 is identified, player/recorder 2 plays back the management information indicated by reference numeral (1) in FIG. 8A, and decryptor 9 performs the decryption with the key data. A copy of the management information indicated by reference numeral (3) in FIG. 8B is played back by player/recorder 7, and decryptor 9 performs the decryption with the key data. Then, both copies are compared by the system controller (not shown). If the comparison results match, the copy of the content indicated by reference numeral (4) in FIG. 8B is played back through player/recorder 7 and decryptor 9 and displayed on display 11. Conversely, if the comparison results do not correspond, the content indicated by reference numeral (2) in FIG. 8A are played back through player/recorder 2 and decryptor 9 and are displayed on display 11. Furthermore, copies of the management information and content on optical disk 1 are recorded over the respective copies so that the copies can be updated and the can match.

The playback operation of exemplary embodiment 2 was described above. According to this example, when information on optical disk 1 matches the information on internal HDD 8, improvement in operability as discussed in the description of the recording operation can be obtained by playing back the information on internal HDD 8. When the information on optical disk 1 does not correspond to the information on internal HDD 8 because additional information has been recorded by a different recorder, for example, the copy may be updated so that both copies match, which is advantageous for the next playback.

As described in exemplary embodiment 1, content may be recorded on internal HDD 8 in a different recording format from that of the content recorded on optical disk 1.

The second recording medium is contained in the player/recorder in the example above. However, when fast processing, the object of the invention, is achieved, that is, when the second recording medium needs only to be a recording medium allowing faster playback processing than the playback processing of the first recording medium, the second recording medium does not have to be contained in the player/recorder but may be a removable recording medium.

Although the preferred embodiments of the invention have been disclosed for illustrative purposes, those skilled in the art will appreciate that various modifications, additions and substitutions are possible without departing from the scope and spirit of the invention as disclosed in the accompanying claims.

What is claimed is:

1. A player/recorder to which a first recording medium storing content can be removably installed, the content being encrypted based on a first key unique to the first recording medium, the player/recorder comprising:
a second recording medium contained therein;
the player/recorder recording the content encrypted based on the first key to the second recording medium; and
a decryptor that decrypts the first key from the installed first recording medium and decrypts content recorded in the second recording medium based on the first key.

2. The player/recorder according to claim 1 wherein content is recorded in the first recording medium and the second recording medium by different encoding methods.

3. The player/recorder according to claim 2 wherein content is recorded in the first recording medium and the second recording medium by different encoding methods.

4. The player/recorder according to claim 2 wherein content is recorded in the first recording medium and the second recording medium at different compression rates.

5. The player/recorder according to claim 1 wherein content recorded in the first recording medium is compressed, and content recorded in the second recording medium is not compressed.

6. The player/recorder according to claim 1 wherein received content is recorded in the second recording medium; and the content recorded in the second recording medium is encrypted based on the first key and is recorded in the first recording medium and the second recording medium.

7. The player/recorder according to claim 1 wherein the first recording medium includes an optical disk and the second recording medium includes a hard disk.

8. A player/recorder to which a first recording medium storing encrypted content can be removably installed, the player/recorder comprising:
a second recording medium contained in the player/recorder; and
the player/recorder recording the encrypted content,
wherein the player/recorder plays back content recorded in the second recording medium when the first recording medium is installed.

9. The player/recorder according to claim 8 wherein content is recorded in the first recording medium and the second recording medium by different encoding methods.

10. The player/recorder according to claim 8 wherein content recorded in the first recording medium is compressed, and content recorded in the second recording medium is not compressed.

11. The player/recorder according to claim 8 wherein:
received content is recorded in the second recording medium; and
the content recorded in the second recording medium is encrypted based on the first key and recorded in the first recording medium and the second recording medium.

12. The player/recorder according to claim 8 wherein the first recording medium includes an optical disk, and the second recording medium includes a hard disk.

13. A player/recorder, comprising:
an encryptor that encrypts received content based on a first key unique to a first recording medium; and
the player/recorder recording the content encrypted by the encryptor to the first recording medium and a second recording medium contained in the player/recorder.

14. The player/recorder according to claim 13 wherein the player/recorder records content to the first recording medium and the second recording medium using different encoding methods.

15. The player/recorder according to claim 14 wherein the player/recorder records content to the first recording medium and the second recording medium using a different encoding methods.

16. The player/recorder according to claim 14 wherein the player/recorder records content to the first recording medium and the second recording medium at different compression rates.

17. The player/recorder according to claim 13 wherein the player/recorder compresses and records content to the first recording medium and records the content to the second recording medium without compression.

18. The player/recorder according to claim 13 wherein the first recording medium includes an optical disk, and the second recording medium includes a hard disk.

19. A content playback method in which a first recording medium is removably installed to a player/recorder, and a second recording medium is contained in the player/recorder, the method comprising:
decrypting a first key for use in encryption of content from the first recording medium storing the encrypted content; and
decrypting and playing back the content recorded in the second recording medium based on the decrypted first key.

20. A content playback method in which a first recording medium is removably installed to a player/recorder, and a second recording medium is contained in the player/recorder, the method including a step of when the first recording medium storing encrypted content is installed in the player/recorder, playing back the content recorded in the second recording medium.

21. A content recording method in which a first recording medium is removably installed to a player/recorder, and a second recording medium is contained in the player/recorder, the method comprising the steps of:
encrypting content based on a first key unique to the first recording medium; and
recording encrypted content to the first recording medium and the second recording medium.
